(19) United States
(12) Patent Application Publication
(10) Pub. No.: US 2018/0278130 A1
(43) Pub. Date: Sep. 27, 2018

(54) BRUSHLESS MOTOR

(71) Applicant: OMRON Corporation

(72) Inventors: Ryuji KAWAMOTO, Ichinomiya-shi (JP); Yoshiki FUKUTA, Kiyosu-shi (JP); Fumiaki ABE, Amagasaki-shi (JP)

(73) Assignee: OMRON Corporation, Kyoto-shi, KYOTO (JP)

(21) Appl. No.: 15/751,953

(22) PCT Filed: Nov. 9, 2016
(86) PCT No.: PCT/JP2016/083267

§ 371 Date: Feb. 12, 2018

(30) Foreign Application Priority Data
Dec. 16, 2015 (JP) 2015-245431

(51) Int. Cl. H02K 11/40; H02K 11/215; H02K 21/22; A63F 7/02

(52) U.S. Cl. CPC H02K 11/40; H02K 11/215; A63F 2250/08; A63F 7/027; H02K 2211/03; H02K 21/22

(57) ABSTRACT

A brushless motor includes: a rotor including a magnet with polarization directions arranged so as to be alternatingly inverted along a circumferential direction centered about a rotation shaft, the rotor being attached to a housing so as to be capable of rotating with the rotation shaft serving as the center of rotation; a stator including multiple coils arranged along the circumferential direction centered about the rotation shaft of the rotor so as to oppose the magnet, the stator causing the rotor to rotate due to interaction between a magnetic field generated by the magnet and magnetic fields generated by the coils due to current flowing in the coils; at least one rotation angle sensor that detects the rotation angle of the rotor; and a protection portion provided at a location farther from the rotation shaft than each rotation angle sensor and formed by a grounded conductor.

### TECHNICAL FIELD

The present invention relates to a brushless motor.

### RELATED ART

Game machines such as slot machines and pinball machines have been provided with innovations for effects that appeal to the player's senses of sight, sound, and touch in order to enhance the player's interest. In particular, game machines have been provided with moving bodies such as moving gadgets in order to appeal to the player's visual sense. In particular, in order to enhance the player's interest, game machines have been provided with large moving gadgets. Driving such a moving gadget requires a motor that has a high torque. In view of this, consideration has been given to driving such a moving gadget with use of a direct current motor that can generate a large torque while being relatively compact (e.g., see Patent Document 1).

Also, among direct current motors, a brushless motor is known in which, instead of using a commutator, the direction of the flow of current in the coil of a stator is switched while using a sensor to detect the rotation angle of a rotor (e.g., see Patent Documents 2 and 3). For example, in the brushless motors disclosed in Patent Documents 1 to 3, Hall elements are used as sensors for detecting the rotation angle of the rotor.

### RELATED ART DOCUMENTS

### Patent Documents

Patent Document 1: JP 2004-166349A

Patent Document 2: JP 561-112563A

Patent Document 3: JP 2008-151774A

### SUMMARY OF THE INVENTION

### Problem to be Solved by the Invention

When a brushless motor is used in a game machine, there are cases where electrostatic discharge occurs in the vicinity of the brushless motor. For example, electrostatic discharge sometimes occurs when a player touches an electrically conductive object. Some pinball-type game machines have a structure in which a game ball falls from the top of a game stand to the bottom thereof while repeatedly colliding with other game balls, pins, or gadgets, and it is known that a very large amount of static electricity is therefore generated by friction during such collisions. If such electrostatic discharge reaches the brushless motor, there is a risk the sensor that detects the rotation angle of the rotor malfunctions, thus resulting in abnormal operation of the brushless motor or the moving gadget that is driven by the brushless motor.

Also, brushless motors that are applied as cooling fan motors, spindle motors for storage devices such as DVD and HDD devices, and the like exclusively use so-called sensorless motors that do not use a rotation angle sensor to detect the rotation angle of the rotor. A large torque is not required at startup in such applications. For this reason, at startup, such brushless motors gradually increase in rotation speed through synchronized operation, and then when an adequate induced voltage has been generated in the non-energized coil, magnetic pole position detection is performed based on the induced voltage, and energization switching is performed. However, in the case of a brushless motor used in a game machine, particularly in the case of a brushless motor used to drive a gadget that involves static friction, a large startup torque is required, and therefore the use of a rotation angle sensor cannot be avoided.

In view of this, an object of the present invention is to provide a brushless motor that can prevent a malfunction caused by static electricity that arrives from the outside.

### Means for Solving the Problems

One aspect of the present invention provides a brushless motor. This brushless motor includes: a housing; a rotor having a rotation shaft and a magnet with polarization directions arranged so as to be alternatingly inverted along a circumferential direction centered about the rotation shaft, the rotor being attached to the housing in a manner of being capable of rotating with the rotation shaft serving as a center of rotation; a stator having a plurality of coils arranged along the circumferential direction centered about the rotation shaft of the rotor so as to oppose the magnet of the rotor, the stator causing the rotor to rotate by interaction between a magnetic field generated by the magnet of the rotor and magnetic fields generated by the plurality of coils due to current flowing in the plurality of coils; at least one rotation angle sensor that detects a rotation angle of the rotor; and a protection portion that is provided at a location farther from the rotation shaft than the at least one rotation angle sensor is, and that is formed by a grounded conductor.

It is preferable that this brushless motor further includes a substrate that is housed in the housing, the at least one rotation angle sensor being attached to the substrate. In this case, it is preferable that the protection portion is formed as a pattern on the substrate.

Alternatively, it is preferable that in this brushless motor, the protection portion is provided in the housing.

### Effects of the Invention

A brushless motor according to the present invention has an effect of making it possible to prevent a malfunction caused by static electricity that arrives from the outside.

### BRIEF DESCRIPTION OF THE DRAWINGS

FIG. 1 is a schematic perspective view of a brushless motor according to one embodiment of the present invention.

FIG. 2 is an exploded perspective view of parts of the brushless motor.

FIG. 3A is an internal perspective view of the brushless motor, and

FIG. 3B is a schematic cross-sectional view of the brushless motor taken along a line indicated by arrows A and A′ in FIG. 3A.

FIG. 4 is a truth table showing an example of the relationship between output voltages from Hall ICs and currents applied to coils of a stator.

FIG. 5 is a schematic plan view of a circuit board.

### EMBODIMENTS OF THE INVENTION

Hereinafter, a brushless motor according to an embodiment of the present invention will be described with reference to the drawings. This brushless motor is provided with guard patterns for protection from static electricity, and these guard patterns are grounded, are constituted by a conductive body, and are located at a position farther from a rotation shaft of a rotor than sensors for detecting the rotation angle of the rotor are. Accordingly, this brushless motor allows static electricity arriving from the outside to escape to a ground electrode via the guard patterns, thus preventing a malfunction of the sensors caused by static electricity.

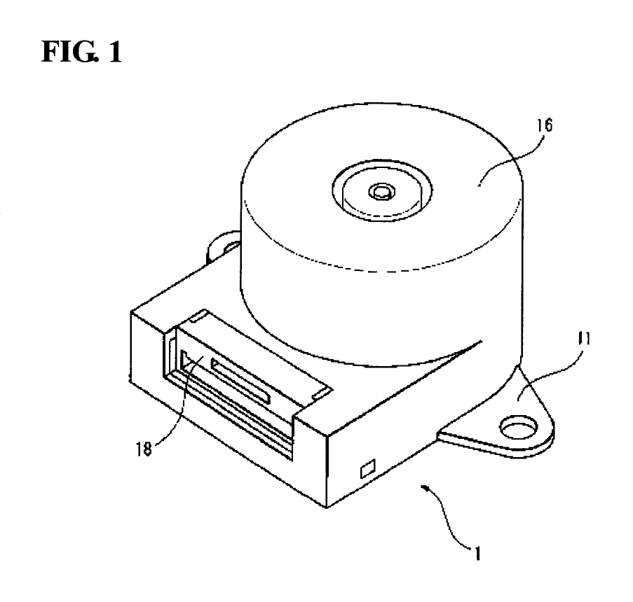

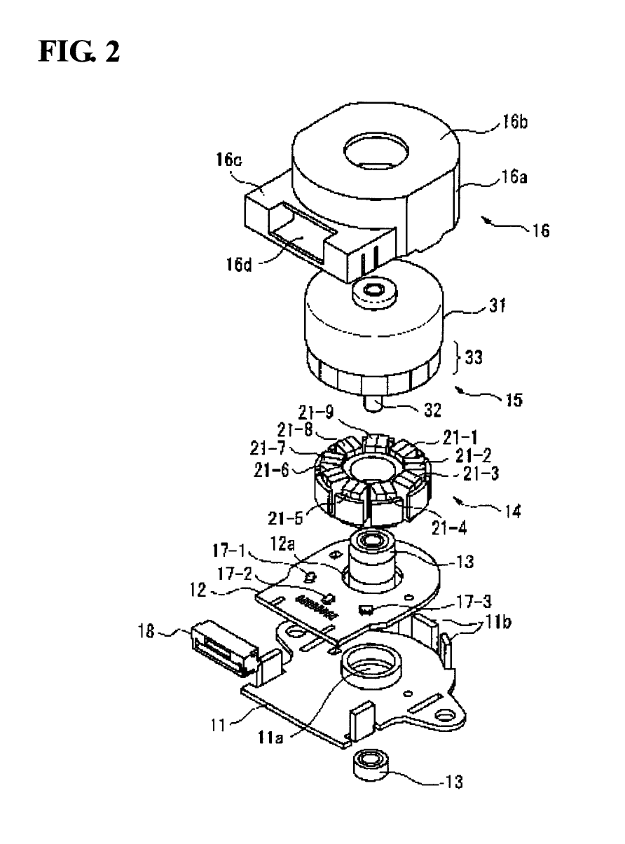

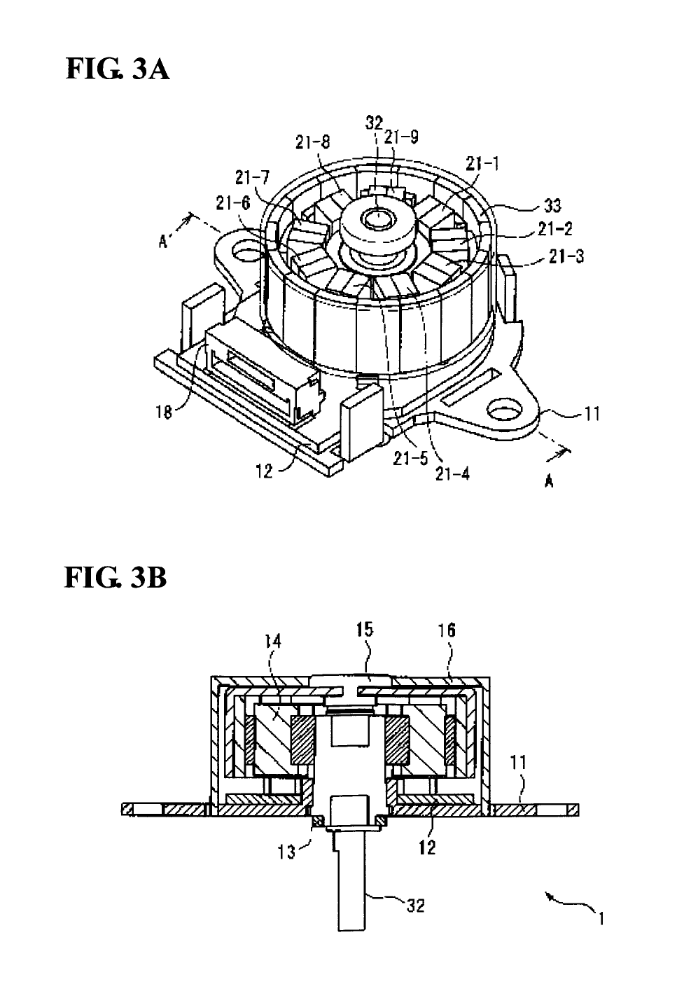

FIG. 1 is a schematic perspective view of a brushless motor 1 according to one embodiment of the present invention. FIG. 2 is an exploded perspective view of parts of the brushless motor 1. Also, FIG. 3A is an internal perspective view of the brushless motor 1, and FIG. 3B is a schematic cross-sectional view of the brushless motor 1 taken along a line indicated by arrows A and A′ in FIG. 3A. As shown in FIGS. 1 to 3B, the brushless motor 1 has a base plate 11, a circuit board 12, a bearing portion 13, a stator 14, a rotor 15, a cover case 16, three Hall ICs 17-1 to 17-3, and a connector 18.

The brushless motor 1 of the present embodiment is a direct current motor, and the direction of current applied to coils of the stator 14 is controlled by a drive circuit (not shown) in accordance with the rotation angle of the rotor 15, which is detected by the Hall ICs 17-1 to 17-3. Note that the brushless motor of the present invention may be a type of brushless motor other than a direct current type, as long as it has a rotation angle sensor that detects the rotation angle of the rotor. Hereinafter, for the sake of convenience in the descriptions, the side on which the base plate 11 is provided in the brushless motor 1 will be considered to be the lower side, and the side on which the cover case 16 is provided will be considered to be the upper side. Note that when the brushless motor 1 is actually attached to another device, such as a game machine, the brushless motor 1 may be arranged with any surface of the brushless motor 1 facing upward.

The base plate 11 forms a housing of the brushless motor 1 along with the cover case 16. The other parts of the brushless motor 1 are housed in the space formed by the base plate 11 and the cover case 16. In the present embodiment, the base plate 11 is made of a resin, for example, and supports the parts of the brushless motor 1. For this reason, the base plate 11 is formed as a flat plate-shaped member, and a circular hole 11a for attachment of the bearing portion 13 and a rotation shaft 32 of the rotor 15 is provided in the approximate center of this member. Multiple outer walls 11b for fixing the cover case 16 and the connector 18 are formed along the outer periphery of the base plate 11.

The circuit board 12 is arranged on the base plate 11 and supports the Hall ICs 17-1 to 17-3. Also, the circuit board 12 is provided with a wiring pattern for connecting the connector 18 to the windings of coils 21-1 to 21-9 of the stator 14, such that the coils 21-1 to 21-9 of the stator 14 can be electrically connected to a drive circuit (not shown) that is provided outside of the brushless motor 1, in order for current to be applied to the coils of the stator 14. The circuit board 12 is further provided with a wiring pattern for connecting the connector 18 to the Hall ICs 17-1 to 17-3 such that the Hall ICs 17-1 to 17-3 can be electrically connected to the drive circuit. Guard patterns for protecting the Hall ICs 17-1 to 17-3 from electrostatic discharge from the outside are also formed on the circuit board 12. A hole 12a for the passage of the bearing portion 13 is also formed in the circuit board 12 at a position of overlapping the hole 11a when the circuit board 12 is attached to the base plate 11. Note that the circuit board 12 will be described in more detail later.

The bearing portion 13 is formed with a cylindrical shape, and is inserted into the hole 11a of the base plate 11 and the hole 12a of the circuit board 12 and attached to the base plate 11 such that the axial direction of the bearing portion 13 is substantially orthogonal to the base plate 11. The rotation shaft 32 of the rotor 15 is supported inside the bearing portion 13 such that the rotor 15 is capable of rotating. For this reason, the bearing portion 13 has one or more ball bearings inside.

The stator 14 is formed with a cylindrical shape, and is arranged on the circuit board 12 so as to surround the rotation shaft 32 of the rotor 15 and the bearing portion 13 and so as to face a permanent magnet 33 of the rotor 15. The stator 14 has nine coils 21-1 to 21-9 that generate a magnetic field for rotating the rotor 15 by interacting with the permanent magnet 33 of the rotor 15. In the present embodiment, the coils 21-1, 21-4, and 21-7 are U phase coils, the coils 21-2, 21-5, and 21-8 are V phase coils, and the coils 21-3, 21-6, and 21-9 are W phase coils. In other words, the coils 21-1 to 21-9 are arranged along a circle centered about of the rotation shaft 32 of the rotor 15, in the order of a U phase coil, a V phase coil, and then a W phase coil in the clockwise direction as viewed from above. Note that the number of coils of the stator 14 is not limited to being nine. The stator 14 may have one or two coils for each phase, for example.

The windings of the coils are electrically connected to a drive circuit via the connector 18 and a wiring pattern provided in the circuit board 12, and generate a magnetic field that corresponds to the direction of the current applied by the drive circuit.

The rotor 15 includes: a support member 31 that has a disc-shaped member and an outer wall member that is cylindrical and extends downward along the outer periphery of the disc-shaped member; a rotation shaft 32 that is shaped as a circular column and is attached to the center of the disc-shaped member of the support member 31; and a permanent magnet 33 that has a cylindrical shape and is arranged along the inner periphery of the outer wall member. The rotor 15 is attached such that the rotation shaft 32 passes through the bearing portion 13, the stator 14 is located inward of the permanent magnet 33, and the permanent magnet 33 opposes the coils 21-1 to 21-9 of the stator 14. The rotor 15 rotates with the rotation shaft 32 serving as the rotation axis, due to interaction between the magnetic fields generated by the coils 21-1 to 21-9 of the stator 14 and the magnetic field generated by the permanent magnet 33.

The permanent magnet 33 is a rare-earth bond magnet, for example. The permanent magnet 33 is attached along the inner periphery of the outer wall of the support member 31 using an adhesive for example, and is magnetized such that the polarization direction is alternatingly inverted along the circumferential direction centered about the rotation shaft 32. In the present embodiment, the permanent magnet 33 is divided into 12 portions along the circumferential direction centered about the rotation shaft 32, and portions with the S pole on the lower side, that is to say portions in which the S pole is on the circuit board 12 are provided so as to alternate with portions in which the N pole is on the lower side. In other words, the polarity of the permanent magnet 33 is set so as to face orthogonal directions with respect to the circumferential direction and a radiating direction centered about the rotation shaft 32. Note that the number of portions in the permanent magnet 33 of the rotor 15 may be less than or more than 12. Alternatively, the rotor 15 may have multiple permanent magnets that are arranged along the inner periphery of the outer wall of the support member 31, that is to say along the circumferential direction centered about the rotation shaft 32. In this case, permanent magnets with the S pole facing downward and permanent magnets with the N pole facing downward are attached so as to alternate along the inner periphery of the outer wall of the support member 31. Note that the permanent magnet 33 may be attached to the support member 31 using another method. The rotor 15 thus rotates in accordance with the magnetic fields generated by the coils 21-1 to 21-9 of the stator 14.

The cover case 16 is formed from a resin for example, forms the housing along with the base plate 11, and houses the other parts of the brushless motor 1. To achieve this, the cover case 16 has a side wall 16a that is formed with a substantially cylindrical shape, and a top plate 16b that is located at the upper side of the rotor 15. A projection portion 16c for housing the connector 18 is formed on a portion of the side wall 16a, and a hole 16d for exposing the connector 18 is formed in a portion of the projection portion 16c.

The Hall ICs 17-1 to 17-3 are examples of rotation angle sensors that detect the rotation angle of the rotor 15 by detecting change in the magnetic field generated by the permanent magnet 33 of the rotor 15. In the present embodiment, the Hall IC 17-1 is for the U phase, the Hall IC 17-2 is for the V phase, and the Hall IC 17-3 is for the W phase. The Hall ICs 17-1 to 17-3 are attached to the circuit board 12 along an arc centered about the rotation shaft 32 of the rotor 15 at 30 degree intervals in the counter-clockwise direction as viewed from above, and oppose the permanent magnet 33 of the rotor 15 along the vertical direction.

The Hall IC 17-1 outputs a relatively high voltage upon detecting a magnetic field oriented from the upper side of the Hall IC 17-1 toward the lower side, that is to say when a portion of the permanent magnet 33 with the N pole on the lower side (the Hall IC 17-1 side) approaches the Hall IC 17-1, and conversely outputs a relatively low voltage upon detecting a magnetic field oriented from the lower side of the Hall IC toward the upper side, that is to say when a portion of the permanent magnet 33 with the S pole on the lower side approaches the Hall IC 17-1. The same follows for the Hall ICs 17-2 and 17-3 as well. Accordingly, the rotation angle of the rotor 15 is detected according to change in the voltages output from the Hall ICs 17-1 to 17-3.

The voltages output from the Hall ICs 17-1 to 17-3 are output to the drive circuit via the connector 18 and a wiring pattern on the circuit board 12.

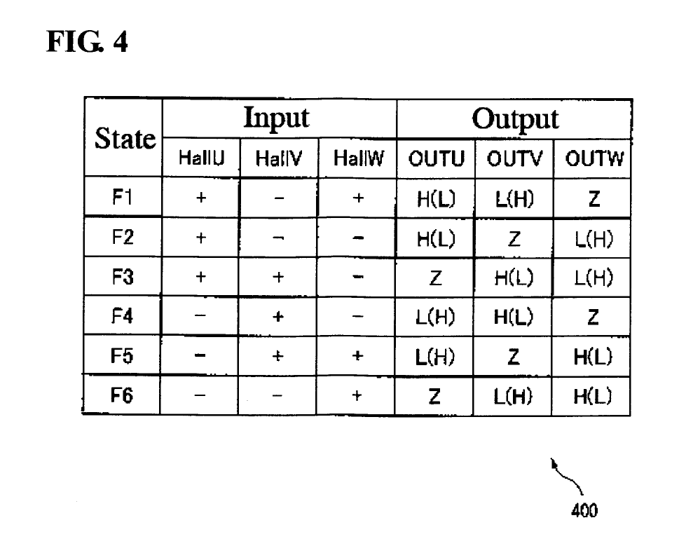

FIG. 4 is a truth table showing an example of the relationship between the output voltages from the Hall ICs 17-1 to 17-3 and the currents applied to coils 21-1 to 21-9 of the stator 14 in the case of rotating the rotor 15 in the clockwise direction as viewed from above. In a truth table 400 shown in FIG. 4, HallU, HallV, and HallW respectively indicate the output voltages of the Hall ICs 17-1, 17-2, and 17-3. The “+” sign indicates a relatively high output voltage, and the “−” sign indicates a relatively low output voltage. Also, OUTU, OUTV, and OUTW respectively indicate the direction of the current applied to the U phase coil, the V phase coil, and the W phase coil. The “H” sign indicates that a current oriented for generation of a magnetic field in a direction away from the permanent magnet 33 of the rotor 15 in the coil is applied to that coil. Also, the “L” sign indicates that a current oriented for generation of a magnetic field in a direction toward the permanent magnet 33 of the rotor 15 in the coil is applied to that coil. The “Z” sign indicates that no current is applied. Note that the current direction indicated in parentheses indicates the direction of current applied to the coils 21-1 to 21-9 in the case of rotating the rotor 15 in the counter-clockwise direction as viewed from above.

In the case where, for example, the output voltages of the Hall IC 17-1 and the Hall IC 17-3 are relatively high, and the output voltage of the Hall IC 17-2 is relatively low, a current oriented for generation of a magnetic field in a direction away from the permanent magnet 33 of the rotor 15 is applied to the U phase coils, and a current oriented for generation of a magnetic field in a direction toward the permanent magnet 33 of the rotor 15 is applied to the V phase coils. No current is applied to the W phase coils. The drive circuit can rotate the rotor 15 by controlling the currents applied to the coils 21-1 to 21-9 in accordance with the truth table 400.

The connector 18 is an interface for connecting the Hall ICs 17-1 to 17-3 and the coils 21-1 to 21-9 of the stator 14 to the drive circuit provided outside of the brushless motor 1. The connector 18 outputs the output voltages from the Hall ICs 17-1 to 17-3 to the drive circuit. Currents applied from the drive circuit are also applied to the coils 21-1 to 21-9 via the connector 18.

The following describes details of the circuit board 12.

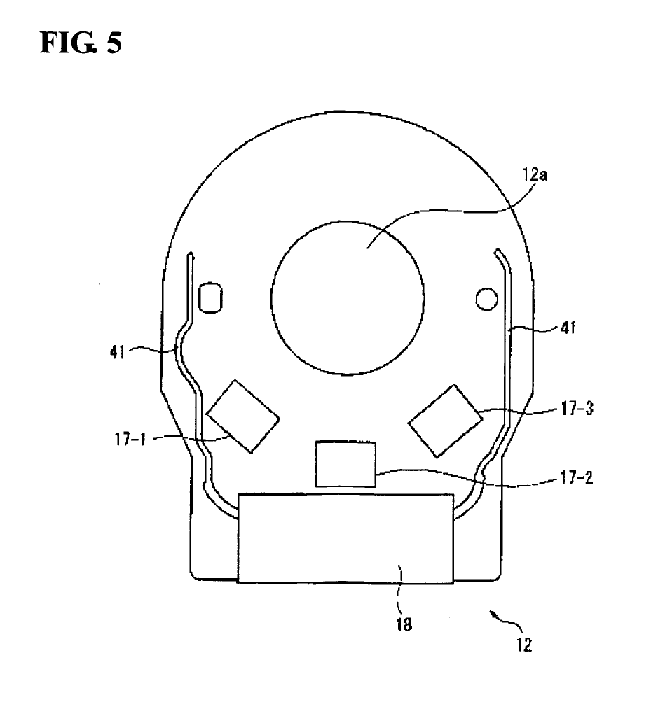

FIG. 5 is a schematic plan view of the circuit board 12. Note that for the sake of simplification, wiring patterns other than the guard patterns are not shown in FIG. 5. As shown in FIG. 5, the circuit board 12 is provided with guard patterns 41 at positions that are separated from the hole 12a, through which the rotation shaft 32 of the rotor 15 passes, by a distance greater than the distance from the hole 12a to the Hall ICs 17-1 to 17-3. The guard patterns 41 are an example of a protection portion, and are formed by a conductor. In the present embodiment, two guard patterns 41 are provided on the circuit board 12, and these two guard patterns are arranged substantially linearly symmetrically about a line that connects the center of the connector 18 and the center of the hole 12a. For this reason, the Hall ICs 17-1 to 17-3 are arranged so as to be surrounded by the two guard patterns 41 and the connector 18. Note that if the direction of arrival of static electricity is envisioned in advance, the guard pattern 41 may be provided in only that direction. For example, in the case where it is envisioned that static electricity arrives from only the left side in FIG. 5, the guard pattern 41 may be provided on only the left side of the Hall ICs 17-1 to 17-3.

Also, the guard patterns 41 are connected to a ground electrode (not shown) provided on the lower surface of the circuit board 12 through vias, for example. The ground electrode is grounded via the connector 18. In other words, the guard patterns 41 are grounded. Note that the guard patterns 41 may be grounded using another method.

In this way, the guard patterns 41 are located outward of the Hall ICs 17-1 to 17-3 in a view from the rotation shaft 32 of the rotor 15. For this reason, static electricity arriving from outside the brushless motor 1 arrives at the guard patterns 41 before arriving at any of the Hall ICs 17-1 to 17-3, and is thus allowed to escape to the ground electrode via the guard patterns 41. The Hall ICs 17-1 to 17-3 can thus be protected from static electricity arriving from the outside. Note that in order to make the guard patterns 41 more likely to capture static electricity, it is preferable that a resist layer is not formed on the surfaces of the guard patterns 41, such that the conductors forming the guard patterns 41 are exposed.

As described above, this brushless motor has the guard patterns for allowing static electricity arriving from the outside to escape to the ground electrode, and these guard patterns are located outward of the Hall ICs that are sensors for detecting the rotation angle of the rotor. For this reason, in this brushless motor, it is possible to protect the Hall ICs from static electricity that arrives from the outside.

A variation is possible in which instead of forming the guard patterns on the circuit board, or in addition to the guard patterns, the entirety of the cover case is formed by a conductor, and is also grounded. In this case, the cover case itself is a protection portion. Alternatively, as another protection portion, a grounded conductor may be provided so as to extend completely around the side wall of the cover case on the inner side or the outer side of the side wall of the cover case. Accordingly, in the brushless motor, static electricity that arrives from the outside can be more reliably allowed to escape to the ground electrode before arriving at sensors such as the Hall ICs.

Also, according to another variation, the permanent magnet may be attached to the rotor such that the permanent magnet is located inward, with respect to the rotation axis of the rotor, of the coils of the stator that are arranged in a circle.

According to yet another variation, instead of Hall ICs, the rotation angle sensors may be Hall elements themselves that output an analog voltage according to the magnitude and direction of the detected magnetic field, or a rotary encoder. In the case of using a rotary encoder as the rotation angle sensor, the rotary encoder has, for example, a disc provided on the rotation shaft of the rotor and provided with slits at predetermined angular intervals along a circumferential direction centered about the rotation shaft of the rotor, and a light emitting element and a light receiving element provided so as to oppose each other with the disc sandwiched therebetween. The light receiving element can receive light from the light emitting element when any of the slits is located between the light receiving element and the light emitting element, and therefore the rotary encoder can detect the rotation angle of the rotor according to the number of times that the light receiving element has received light from the light emitting element. In this case as well, it is sufficient that the protection portion is provided at a location that is farther from the rotation shaft than the light receiving element of the rotary encoder is.

In this way, a person skilled in the art can make various changes according to the manner of implementation within the scope of the present invention.

### INDEX TO THE REFERENCE NUMERALS

1 brushless motor

11 base plate

12 circuit board

13 bearing portion

14 stator

15 rotor

16 cover case

17-1˜17-3 Hall IC

18 connector

21-1˜21-9 coil

31 support member

32 rotation shaft

33 permanent magnet

41 guard pattern

1. A brushless motor comprising:
a housing;
a rotor having a rotation shaft and a magnet with polarization directions arranged so as to be alternatingly inverted along a circumferential direction centered about the rotation shaft, the rotor being attached to the housing in a manner of being capable of rotating with the rotation shaft serving as a center of rotation;
a stator having a plurality of coils arranged along the circumferential direction centered about the rotation shaft so as to oppose the magnet of the rotor, the stator causing the rotor to rotate by interaction between a magnetic field generated by the magnet of the rotor and magnetic fields generated by the plurality of coils due to current flowing in the plurality of coils;
at least one rotation angle sensor that detects a rotation angle of the rotor; and
a protection portion that is provided at a location farther from the rotation shaft than the at least one rotation angle sensor is, and that is formed by a grounded conductor.

2. The brushless motor according to claim 1, further comprising:
a substrate that is housed in the housing, the at least one rotation angle sensor being attached to the substrate,
wherein the protection portion is formed as a pattern on the substrate.

3. The brushless motor according to claim 1, wherein the protection portion is provided in the housing.
